(19) United States
(12) Patent Application Publication
(10) Pub. No.: US 2024/0247942 A1
(43) Pub. Date: Jul. 25, 2024

(54) NOTIFICATION SYSTEM

(71) Applicant: TOYOTA JIDOSHA KABUSHIKI KAISHA, Toyota-shi (JP)

(72) Inventors: Shunsuke MOGI, Tokyo (JP); Shuta YOKOTA, Susono-shi (JP); Susumu OIKAWA, Yokohama-shi (JP); Takahiro SAKAMOTO, Toyota-shi (JP); Miyu HAGA, Atsugi-shi (JP); Kenjo MIYASHITA, Susono-shi (JP); Naotoshi KADOTANI, Mishima-shi (JP)

(73) Assignee: TOYOTA JIDOSHA KABUSHIKI KAISHA, Toyota-shi (JP)

(21) Appl. No.: 18/529,017

(22) Filed: Dec. 5, 2023

(30) Foreign Application Priority Data
Jan. 20, 2023 (JP) 2023-007458

(51) Int. Cl. G01C 21/36

(52) U.S. Cl. CPC G01C 21/3641

(57) ABSTRACT

The notification system that notifies the user of the transfer service that has boarded the vehicle that is able to travel autonomously and provides the transfer service is configured to notify the user when the travel route to the destination of the vehicle is different from the past travel route when the user has moved to the destination or the vicinity of the destination in the past.

### CROSS-REFERENCE TO RELATED APPLICATION

This application claims priority to Japanese Patent Application No. 2023-007458 filed on Jan. 20, 2023, incorporated herein by reference in its entirety.

### BACKGROUND

### 1. Technical Field

The disclosure relates to a notification system.

### 2. Description of Related Art

Japanese Unexamined Patent Application Publication No. 2016-133328 (JP 2016-133328 A) discloses a route searching system that is installed in an automated driving vehicle, and that searches for a route from a departure point to a destination of the automated driving vehicle.

### SUMMARY

It is envisioned that transportation services, in which a user rides in an unmanned service vehicle capable of traveling autonomously and the user is transported to a destination specified by the user, will be widely used in the future. When the user is transported to a destination by the unmanned service vehicle, a travel route to the destination set on the system side may be different from a travel route to the destination assumed by the user. When the service vehicle is unmanned, no communication can be held with a driver, and accordingly when the travel route of the service vehicle is different from the assumed travel route, the user may feel anxiety as to whether the service vehicle is traveling toward the specified destination.

The disclosure has been made in light of such a problem, and an object of the disclosure is to suppress a user from feeling anxiety when using a service vehicle.

In order to solve the above problem, a notification system according to an aspect of the disclosure is a system that performs notification to a user of a transportation service who has boarded a vehicle that is able to travel autonomously and provides the transportation service. The notification system is configured to notify the user when a travel route to a destination of the vehicle is different from a past travel route when the user relocated to the destination or a vicinity of the destination in the past.

According to this aspect of the disclosure, the notification is performed when the travel route of the service vehicle is different from the travel route assumed by the user, and accordingly the user can use the service vehicle without feeling anxiety.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a transfer service providing system according to an embodiment of the present disclosure; and

FIG. 2 is a diagram illustrating a notification process according to an embodiment of the present disclosure.

### DETAILED DESCRIPTION OF EMBODIMENTS

Hereinafter, embodiments of the present disclosure will be described in detail with reference to the drawings. In the following description, the same reference numerals are given to the same constituent elements.

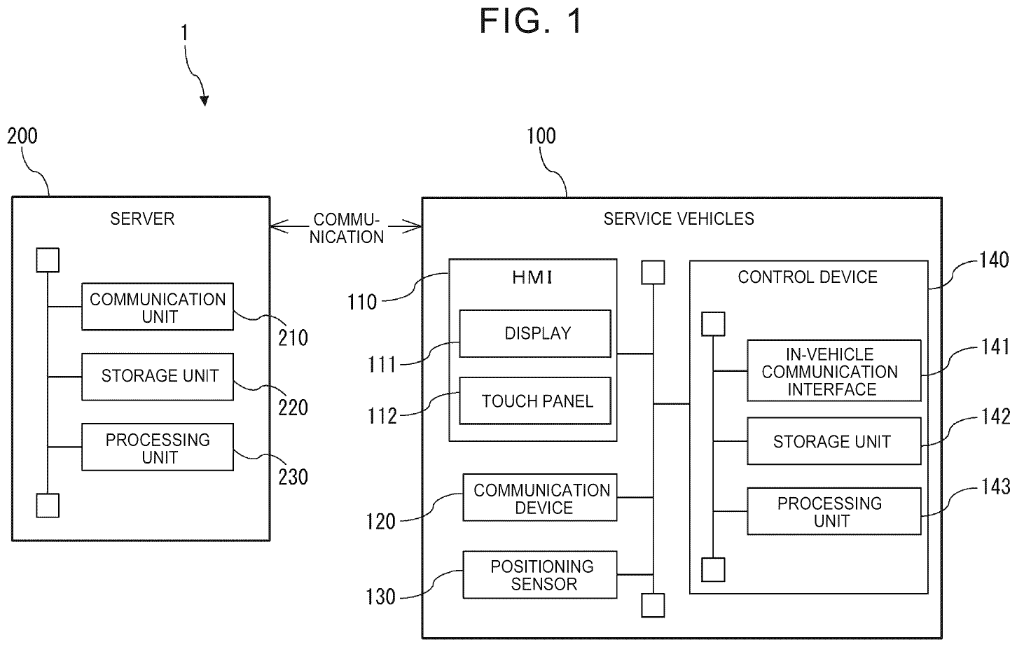

FIG. 1 is a schematic configuration diagram of a notification system 1 according to an embodiment of the present disclosure.

The notification system 1 includes a service vehicle 100 and a server 200. The notification system 1 is a system for notifying the user of the transfer service that has ridden the service vehicle 100 providing the transfer service.

The service vehicle 100 is an unmanned vehicle capable of autonomous traveling, and transports the user to a destination designated by the user by causing the user who uses the transportation service to ride. The service vehicle 100 includes a human machine interface (HMI) 110, a communication device 120, a positioning sensor 130, and a control device 140. HMI 110, the communication device 120, the positioning sensor 130, and the control device 140 are communicably connected via an in-vehicle network 150 compliant with standards such as a controller area network and in-vehicle Ethernet, respectively.

HMI 110 is an interface for exchanging information with a user who has ridden on the service vehicle 100. HMI 110 according to the present embodiment includes a display 111 as an information display screen arranged at a position visible to a user riding on the service vehicle 100, and a touch panel 112 as an operation device for the user to perform an input operation or a response operation. HMI 110 displays the output information (e.g., text information and picture information) output from the control device 140 on the display 111 and outputs the input information input via the touch panel 112 to the control device 140.

Note that HMI 110 is not mounted on the service vehicle 100 as described above, and may be a terminal such as a smart phone owned by a user. In this case, information may be exchanged between the terminal of the user and the service vehicle 100 by performing communication by short-range wireless communication. In addition, communication may be performed between the terminal of the user and the server 200, and information may be indirectly exchanged with the service vehicle 100 via the server 200.

The communication device 120 has a communication interface circuit for connecting to a network constituted by an optical communication line or the like, and is configured to connect the service vehicle 100 to the server 200 via a network (not shown) so as to communicate with the server 200.

The positioning sensor 130 generates current position information indicating the current position of the service vehicle 100, and outputs the generated current position information of the service vehicle 100 to the control device 140.

The control device 140 includes an in-vehicle communication interface 141, a storage unit 142, and a processing unit 143.

The in-vehicle communication interface 141 has a communication interface circuit for connecting the control device 140 to the in-vehicle network 150. The in-vehicle communication interface 141 is configured to be able to communicate with each other between the control device 140 and another device such as a HMI 110 connected to the in-vehicle network 150.

The storage unit 142 includes a storage medium such as a hard disk drive (HDD), a solid state drive (SSD), or a semiconductor memory, and stores various computer programs and data used for processing in the processing unit 143. The storage unit 142 stores, for example, map information necessary for setting a travel route of the service vehicle 100.

The processing unit 143 includes one or a plurality of central processing units (CPU) and peripheral circuits thereof, and executes various computer programs stored in the storage unit, and is, for example, a processor.

The server 200 includes a communication unit 210, a storage unit 220, and a processing unit 230.

The communication unit 210 has a communication interface circuit for connecting the server 200 to a network (not shown) including an optical communication line or the like, and is configured to connect the server 200 to the service vehicle 100 via the network so as to communicate with the service vehicle 100.

The storage unit 220 includes a storage medium such as a hard disk drive (HDD), a solid state drive (SSD), or a semiconductor memory, and stores various computer programs and data used for processing in the processing unit 230.

The processing unit 230 includes one or a plurality of central processing units (CPU) and peripheral circuits thereof, and executes various computer programs stored in the storage unit 220 to comprehensively control the overall operation of the server 200, and is, for example, a processor.

When the user is transported to the destination by the unmanned service vehicle 100 capable of autonomous traveling, the travel route to the destination set by the service vehicle 100 may be different from the travel route to the destination assumed by the user. In the case of the unmanned service vehicle, since communication with the driver cannot be achieved, if the travel route of the service vehicle 100 is different from the assumed travel route, there is a possibility that the user may feel anxiety as to whether the service vehicle 100 is traveling toward the destination as specified.

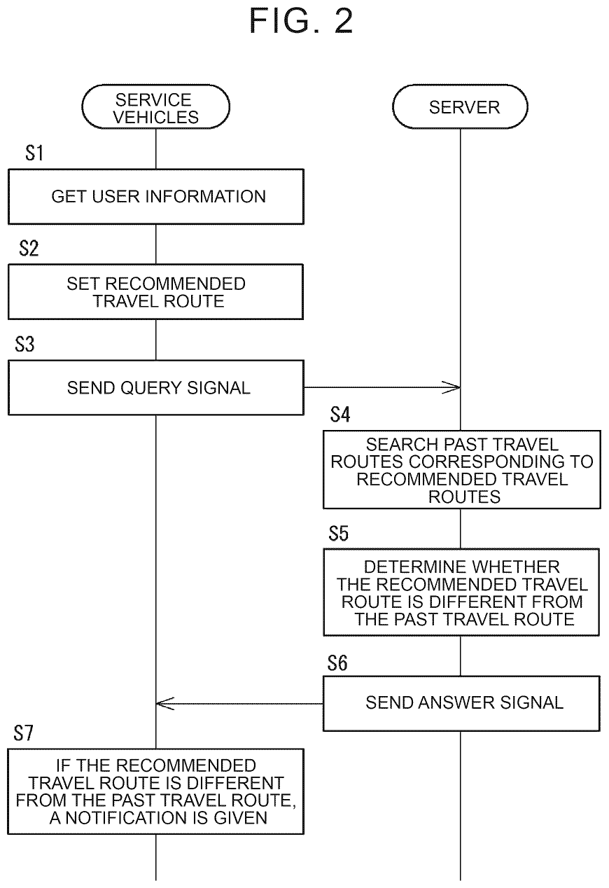

Therefore, in the present embodiment, in order to eliminate such anxiety, when the traveling route to the destination set by the service vehicle 100 is different from the past traveling route of the user, it is possible to notify the user in advance. Hereinafter, an example of processing performed by the service vehicle 100 (more specifically, the processing unit 143 of the control device 140) and the server 200 (more specifically, the processing unit 230) in order to perform such notification will be described with reference to FIG. 2.

FIG. 2 is a sequence diagram illustrating details of the notification process according to the present embodiment.

In S1, the service vehicle 100 acquires the user data of the riding user via HMI 110. The user information is information that needs to be input by the user to provide the transport service, and includes, for example, identification information of the user, destination information of the user, and the like.

In S2, the service vehicle 100 sets a recommended travel route from the current location to the destination of the user based on the destination information of the user, the current location information of the service vehicle 100, and the map information. The recommended travel route is, for example, the shortest route to the destination. In the setting of the recommended travel route, in addition to the above information, other information such as road traffic information may be taken into consideration. In addition, the server 200 may be caused to set the recommended traveling route.

In S3, the service vehicle 100 transmits an inquiry signal including the identification information of the user and the information on the recommended travel route to the server 200, and requests the server 200 to inquire about the past travel history of the user.

In the present embodiment, it is assumed that each user of the transfer service periodically transmits the time-series data of the position information acquired by the owning terminal, the private vehicle, or the like to the server 200 in association with his/her own identification information. The server 200 stores the received time-series data of the position information of each user in the storage unit 220 as the past travel history of each user. In other words, in the present embodiment, routes used by each user of the transfer service in the past are aggregated and stored in the server 200 as the past travel history of each user. The past travel history of each user includes not only a case where an unmanned transfer service is used but also a route traveled when a manned transfer service is used, a route traveled by a person on foot, a bicycle, a private car, or the like. Note that the transmission of the time-series data of the position information from the terminal to the server 200 can be automatically performed by, for example, an application for a transfer service installed in the owning terminal.

In S4, upon receiving the inquiry signal, the server 200 identifies the user who has ridden on the service vehicle 100 as the transmission source of the signal on the basis of the identification information, and searches, based on the past travel history of the user stored in the storage unit 220, whether the travel route corresponding to the recommended travel route exists in the past travel route of the user.

The travel route corresponding to the recommended travel route may be, for example, a travel route in which the departure point is within a certain range centered on the departure point of the recommended travel route and the destination is within a certain range centered on the destination of the recommended travel route among the past travel routes of the user. That is, the traveling route corresponding to the recommended traveling route in the present embodiment is a traveling route in which the departure point and the destination of the user's past traveling route coincide with or substantially coincide with the departure point and the destination of the recommended traveling route, respectively.

In the search of the travel route corresponding to the recommended travel route, search conditions such as the latest degree, the travel frequency, and the part of day can be set. For example, by setting the latest degree such as the past several months or the past several years as a search condition, it is possible to search whether there is a travel route corresponding to the recommended travel route from among the travel routes of the past certain period of the user, so that it is possible to perform a search reflecting the recent tendency of the user. Further, as a search condition, by setting a traveling frequency such as a traveling route that has traveled many times or more in the past, it is possible to perform a search that reflects the preference of the user. Further, as the search condition, it is possible to search whether or not there is a travel route corresponding to the recommended travel route from among the travel routes traveled in the same part of day as the current one, and therefore, it is possible to perform a search reflecting the road traffic situation that varies depending on the part of day. All of these search conditions may be enabled, or only one of them may be enabled.

In S5, when the travel route corresponding to the recommended travel route is present in the past travel route of the identified user, the server 200 determines whether the recommended travel route is different from the travel route corresponding to the recommended travel route. That is, in the travel route corresponding to the recommended travel route, it is determined whether or not there is a travel route that has arrived from the departure point to the destination on a route different from the recommended travel route.

In S6, the server 200 transmits answer signals including information about S5 decisions to the service vehicle 100 from which the query signals are sent.

In S7, when the service vehicle 100 receives the answer signal, the service vehicle 100 refers to the information related to the determination result in S5. When the recommended traveling route and the traveling route corresponding to the recommended traveling route are different from each other, the user is notified of the difference via HMI 110. In the present embodiment, the service vehicle 100 causes the display 111 to display text information such as “go through a route different from the past use route of the customer”. In addition to this notification, the user may be allowed to select, via HMI 110, which traveling route the user is going to the destination.

The notification system 1 according to the present embodiment described above is a system for notifying a user of a transfer service that has ridden on the service vehicle 100 capable of autonomous traveling providing the transfer service, and is configured to notify the user when the travel route to the destination of the service vehicle 100 is different from the past travel route when the user has moved to the destination or the vicinity of the destination in the past.

Thus, even if the travel route of the service vehicle is different from the travel route assumed by the user, the user can use the service vehicle 100 without feeling anxiety.

When the travel route to the destination of the service vehicle is different from the past travel route, it is also possible to notify the user to select whether or not to use the past travel route together with the notification. As a result, it is possible to travel to the destination by using the travel route that is favored by the user, and thus it is possible to suppress the user from feeling dissatisfaction with the transfer service.

Further, by searching for the past travel route from the travel route that the user has traveled in the latest predetermined period, the travel route to the destination of the service vehicle 100 can be compared with an appropriate past travel route that reflects the tendency of the user's recent route selection.

Further, by searching for the past travel route from among the travel routes that the user has traveled a predetermined number of times or more in the past, it is possible to compare the travel route to the destination of the service vehicle 100 with an appropriate past travel route reflecting the user's preference.

Further, by searching for the past travel route from the past travel route traveled by the user in the same part of day, the travel route to the destination of the service vehicle 100 can be compared with an appropriate past travel route reflecting the road traffic situation that changes according to the part of day.

Although the embodiments of the present disclosure have been described above, the embodiments are merely a part of application examples of the present disclosure and are not intended to limit the technical scope of the present disclosure to the specific configurations of the above embodiments.

For example, in the above-described embodiment, the computer program (notification processing) executed in the service vehicle 100 (processing unit 143) and the server 200 (processing unit 230) may be provided in a form recorded in a computer-readable portable recording medium such as a semiconductor memory, a magnetic recording medium, or an optical recording medium.

In the above-described embodiment, the process of S1 and S2 in FIG. 2 is performed by the service vehicle 100, but these processes may be performed by the server 200, and the information regarding the determination result of S5 may be provided to the service vehicle 100 (or the terminal owned by the user) as appropriate.

As described above, HMI 110 is not mounted on the service vehicle 100, but may be a terminal such as a smart phone owned by the user. Thus, the notification to the user can also be performed by the user's owning terminal.

What is claimed is:

1. A notification system that is a notification system that performs notification to a user of a transportation service who has boarded a vehicle that is able to travel autonomously and provides the transportation service, wherein the notification system notifies the user when a travel route to a destination of the vehicle is different from a past travel route when the user relocated to the destination or a vicinity of the destination in a past.

2. The notification system according to claim 1, wherein, when performing notification that the travel route of the vehicle to the destination is different from the past travel route, the notification system also notifies the user, along with the notification, to select whether to use the past travel route.

3. The notification system according to claim 1, wherein the past travel route is searched from travel routes that the user has traveled in a most recent predetermined period.

4. The notification system according to claim 1, wherein the past travel route is searched from travel routes that the user has traveled a predetermined number of times or more in the past.

5. The notification system according to claim 1, wherein the past travel route is searched from travel routes traveled by the user in the past in the same part of day.
